(19) United States
(12) Patent Application Publication
(10) Pub. No.: US 2021/0137784 A1
(43) Pub. Date: May 13, 2021

(54) Massage Apparatus

(71) Applicant: Li Zhijian, Fuzhou (CN)

(72) Inventor: Li Zhijian, Fuzhou (CN)

(21) Appl. No.: 17/149,806

(22) Filed: Jan. 15, 2021

Related U.S. Application Data
(63) Continuation-in-part of application No. 16/885,324, filed on May 28, 2020.
Application No. 16/885,324 is a continuation-in-part of application No. 16/850,043, filed on Apr. 16, 2020.
Application No. 16/850,043 is a continuation-in-part of application No. 16/693,259, filed on Nov. 23, 2019.
Application No. 16/850,043 is a continuation-in-part of application No. 16/693,452, filed on Nov. 25, 2019, now Pat. No. 10,888,494.
Application No. 16/693,452 is a continuation-in-part of application No. 16/885,324, filed on May 28, 2020.
Application No. 16/885,324 is a continuation-in-part of application No. 16/693,259, filed on Nov. 23, 2019.
Application No. 16/850,043 is a continuation-in-part of application No. 16/693,452, filed on Nov. 25, 2019, now Pat. No. 10,888,494.
Application No. 16/693,452 is a continuation-in-part of application No. 16/850,043, filed on Apr. 16, 2020.
Application No. 16/850,043 is a continuation-in-part of application No. 16/693,259, filed on Nov. 23, 2019.
Application No. 16/850,043 is a continuation-in-part of application No. 16/693,452, filed on Nov. 25, 2019, now Pat. No. 10,888,494.
Application No. 16/693,452 is a continuation-in-part of application No. 16/693,452, filed on Nov. 25, 2019, now Pat. No. 10,888,494.
Application No. 16/693,452 is a continuation-in-part of application No. 16/693,259, filed on Nov. 23, 2019.
Application No. 16/693,259 is a continuation-in-part of application No. 16/693,259, filed on Nov. 23, 2019.
(60) Provisional application No. 62/854,261, filed on May 29, 2019.
(60) Provisional application No. 62/834,551, filed on Apr. 16, 2019.
(60) Provisional application No. 62/834,551, filed on Apr. 16, 2019.
(60) Provisional application No. 62/854,261, filed on May 29, 2019.
(60) Provisional application No. 62/854,261, filed on May 29, 2019.
(60) Provisional application No. 62/834,551, filed on Apr. 16, 2019.
(60) Provisional application No. 62/834,551, filed on Apr. 16, 2019.
(60) Provisional application No. 62/854,261, filed on May 29, 2019.
(60) Provisional application No. 62/834,551, filed on Apr. 16, 2019.
(60) Provisional application No. 62/834,551, filed on Apr. 16, 2019.
(60) Provisional application No. 62/854,261, filed on May 29, 2019.

(30) Foreign Application Priority Data
Jan. 11, 2019 (CN) 201910028229.9

(51) Int. Cl. A61H 37/00

(52) U.S. Cl. CPC A61H 37/00; A61H 2201/0107; A61H 2201/1652; A61H 2201/5097; A61H 2201/5007

(57) ABSTRACT

A massaging apparatus system with a convenient replaceable control circuit, having a body; at least one massage head; a control circuit; and a substantially closed storage space having at least one exit with a width of at least 10 mm, wherein the control circuit is stored in the substantially closed storage space, wherein the control circuit has at least one cable connecting with the at least one massage head, wherein the cable goes through the at least one exit and has at least one fast connector which connects and disconnects the control circuit and massage head.

This application claims priority to application Ser. No. 16/885,324 filed May 28, 2020, which in turn claims priority to provisional patent application 62/854,261 filed May 29, 2019. Application Ser. No. 16/885,324 is a continuation-in-part of application Ser. No. 16/850,043 filed Apr. 16, 2020. Application Ser. No. 16/850,043 claims priority to provisional patent application 62/834,551 filed Apr. 16, 2019 and application Ser. No. 16/693,259 filed Nov. 23, 2019, which in turn claims priority to patent application 62/834,551 and Chinese patent application 20190028229.9 filed Jan. 11, 2019. Application Ser. No. 16/885,324 is a continuation-in-part and claims priority to patent application Ser. No. 16/693,452 filed Nov. 25, 2019, which in turn claims priority to patent application Ser. No. 16/693,259 filed Nov. 23, 2019. Each of these applications (Ser. No. 16/855,324, 62/834,551, 16/693,259, Chinese patent application 20190028229.9, 16/693,452, 16/850,043 and 62/854,261) are incorporated herein by reference.

### BRIEF DESCRIPTION OF THE INVENTION

According to one aspect of the present invention, a massaging apparatus system with a convenient replaceable control circuit is provided, comprising, a body; at least one massage head; a control circuit; and a substantially closed storage space having at least one exit with a width of at least 10 mm, wherein the control circuit is stored in the substantially closed storage space, wherein the control circuit has at least one cable connecting with the at least one massage head, and wherein the cable goes through the at least one exit and has at least one fast connector which connects and disconnects the control circuit and massage head.

According to another aspect of the present invention, a massaging apparatus system with a convenient replaceable control circuit is provided, comprising, a body; at least one massage head; a control circuit; a substantially closed storage space having at least one exit having a width of at least 10 mm, and a fastener to secure the substantially closed storage space opening, a substantially closed storage space having a second exit for cable going through, wherein the control circuit is stored in the substantially closed storage space, wherein the control circuit has at least one cable with at least one fast connector that connects and disconnects the control circuit and massage head and goes through the second exit. It is important that the width is at least 10 mm to accommodate removal and entry of the massage heads, and replaceable control circuit. It has been found that a smaller width is contrary to the convenience replaceable nature of the present invention.

### BRIEF DESCRIPTION OF THE DRAWINGS

FIG. 1 depicts a massage apparatus with a fast connector according to the present invention;

FIG. 2 depicts a massage apparatus with a fast connector according to the present invention;

FIG. 3 depicts a massage apparatus with a fast connector according to the present invention;

FIG. 4 depicts a massage apparatus with a wired solid function control board according to the present invention;

FIG. 5 depicts a massage apparatus with a wireless connection control board according to the present invention;

FIG. 6 depicts a massage apparatus according to the present invention;

FIG. 7 depicts a massage apparatus according to the present invention;

FIG. 8 depicts a massage apparatus according to the present invention;

FIG. 9 depicts a massage apparatus according to the present invention;

FIG. 10 depicts a massage apparatus according to the present invention;

FIG. 11 depicts a massage apparatus according to the present invention;

FIG. 12 depicts a massage apparatus according to the present invention;

FIG. 13 depicts a fast connector of a massage apparatus according to the present invention;

FIG. 14 depicts a fast connector of a massage apparatus according to the present invention;

FIG. 15 depicts a fast connector of a massage apparatus according to the present invention;

FIG. 16 depicts a fast connector of a massage apparatus according to the present invention;

FIG. 17 depicts a fast connector of a massage apparatus according to the present invention;

FIG. 18 depicts a fast connector of a massage apparatus according to the present invention;

FIG. 19 depicts a fast connector of a massage apparatus according to the present invention; and

FIG. 20 depicts a fast connector of a massage apparatus according to the present invention. FIGS. 21, 22, 23, 24, 25, 25, 26 and 27 depict aspects of the present invention.

### DETAILED DESCRIPTION OF THE INVENTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) in various places throughout this specification are not necessarily all referring to the same embodiment. Furthermore, the particular features, structures, or characteristics may be combined in any suitable manner in one or more embodiments. Also, depending on the context of discussion herein, a singular term may include its plural forms and a plural term may include its singular form. Similarly, a hyphenated term may be occasionally interchangeably used with its non-hyphenated version and a capitalized entry may be interchangeably used with its non-capitalized version. Such occasional interchangeable uses shall not be considered inconsistent with each other.

With reference to FIGS. 1-8 and 21-25, a massaging apparatus system (10) with a convenient replaceable control circuit, comprising a body (70); at least one massage head (e.g. 61, 63, 65 and 67); a control circuit (30). There may be a substantially closed storage space (60) having at least one exit (62) with a width of at least 10 mm. The substantially closed storage space opening be made by elastic material. The control circuit (64) may be stored in the substantially closed storage space (60). The control circuit (64) has at least one cable (66) connecting with the at least one massage head, wherein the cable goes through the at least one exit (62) and has at least one fast connector (68) which connects and disconnects the control circuit (64) and massage head (e.g. 61, 63, 65 and 67). The substantially closed storage space may further comprise a second exit (69) and the cable (66) may go through the second exit (69). The exit (62) and second exit (69) of the substantially closed storage space may have a fastener (2101) to secure the opening. The fastener can be selected from a group of velcro, snap, zipper, strips. The exit (2502) may also be designed as an elastic opening capable of expanding and contracting

As shown in FIGS. 1, 2, 7, 8 and 26-27, the body has a power source storage space (2601) and a power source (2602), and the power source is connected with a cable with a power source connector (28) extended from the substantially closed storage space.

As shown in FIGS. 7-8, there may be a function control board (71) in communication with the control circuit (73). The function control board (71) may be located in the shoulder strap of body (75), and connected by a cable (77) extended from the substantially closed storage space (79). As shown in FIG. 12, there may be a substantially rigid material (1200) under the function control board (1202). This add stability to the function control board. By way of example, the substantially rigid material (1200) may be plastic board, paper/card board and thick stiff fabric. The body (75) and the substantially closed storage space (79) may be a detachable panel of the body.

FIGS. 3, 4 and 5 depict that the function control board (32) may be a wired solid function control board (e.g. 32 and 40) or may be a wireless connection control board (32). This may act as a controller to turn on and off the massage heads (34, 36, 38 and 40). The function control board (32) may control all the functions of the massage head, such as, intensity, heat, length of time, type of massage. This is by example, only, and without limitation.

As shown in FIGS. 1 and 2, the cable (27) forks to at least two cables (20, 21, 22, 23, 24) to connect with the control circuit (25), the massage heads in the body, a power source connector (28), and connecting the function control board.

As shown in FIGS. 9, 10, 11 and 12, the control circuit may further comprise a second cable (1203), wherein the second cable has at least one fast connector to connect and disconnect the function control board and the control circuit. The control circuit may further comprising a third cable (1204), wherein the third cable has at least one fast connector that connects and disconnects to a power source or a power source connector and the control circuit.

As shown in FIG. 27, the body may further comprising a second substantially closed storage space (2701, 2702) with exit to replace the massage head and for the cable to go through.

The cable connecting to the control circuit may be removed from the exit to disconnect the cable from the control circuit and replace the control circuit.

The control circuit may further comprise at least a fast connector detachably connecting the fast connector on the cable. FIGS. 13, 14, 15, 16, 17, 18, 19 and 20 depict an example of a fast connector. As shown, there may be a female end (1300) and a male end (1302). The female end (1300) has openings (1304) that receive the pins (1306). As shown in FIG. 14, the female end (1400) may receive the male end (1402) to provide a connected fast connector (1404). As shown in FIGS. 15, 16 and 17, the female end (1500) may have a first leg (1502) and a second leg (1504) that protrude from the sides of the female end (1500). These may be received in a first recess (1700) and a second recess (1702) of the male end. The female end may also have a top protrusion (1708) that is receive in a third recess (1706). The fast connector may be in a cable proximal to the control circuit. The Control circuit may be connected to other parts of the massaging apparatus, such as massage heads, function control board, battery, and other parts by the fast connector. After connection, each part of the body, bag or baby carrier may be sewed up. This helps to simplify the production process, avoiding that different massage parts hinder the sewing process of the backpack or baby carrier. Because the different massage parts are placed in different areas of the body of backpack/baby carrier. This will greatly increase productivity. And this advantaged invention will also great help to reduce the product after-sale cost, because the consumer can replace the control circuit in case of any quality problem caused.

I claim:

1. A massaging apparatus system with a convenient replaceable control circuit, comprising,
a body;
at least one massage head;
a control circuit; and
a substantially closed storage space having at least one exit with a width of at least 10 mm, wherein the control circuit is stored in the substantially closed storage space,
wherein the control circuit has at least one cable connecting with the at least one massage head,
wherein the cable goes through the at least one exit and has at least one fast connector which connects and disconnects the control circuit and massage head.

2. A massaging apparatus system with a convenient replaceable control circuit as in claim 1, wherein the body has a power source storage space and a power source, and the power source is connected with a cable extended from the substantially closed storage space.

3. A massaging apparatus system with a convenient replaceable control circuit as in claim 1, wherein the substantially closed storage space further comprising a second exit, and the cable goes through the second exit.

4. A massaging apparatus system with a convenient replaceable control circuit as in claim 1, wherein the exit of the substantially closed storage space has a fastener to secure the opening.

5. A massaging apparatus system with a convenient replaceable control circuit as in claim 1, wherein the substantially closed storage space opening be made by elastic material.

6. A massaging apparatus system with a convenient replaceable control circuit as in claim 1, further comprising a function control board in communication with the control circuit.

7. A massaging apparatus system with a convenient replaceable control circuit as in claim 6, the function control board located in the shoulder strap of body, and connected by a cable extended from the substantially closed storage space.

8. A massaging apparatus system with a convenient replaceable control circuit as in claim 7, further comprising a substantially rigid material under the function control board.

9. A massaging apparatus system with a convenient replaceable control circuit as in claim 1, wherein the cable forks to at least two cables to connect with the control circuit, the massage heads in the body, a power source, and connecting the function control board.

10. A massaging apparatus system with a convenient replaceable control circuit as in claim 1, the control circuit further comprising a second cable, wherein the second cable has at least one fast connector to connect and disconnect the function control board and the control circuit.

11. A massaging apparatus system with a convenient replaceable control circuit as in claim 1, further comprising a third cable, wherein the third cable has at least one fast connector that connects and disconnects to a power source and the control circuit.

12. A massaging apparatus system with a convenient replaceable control circuit as in claim 1, the body further comprising a second substantially closed storage space with exit to replace the massage head and for the cable to go through.

13. A massaging apparatus system with a convenient replaceable control circuit as in claim 1, wherein the cable connecting to the control circuit can be removed from the exit to disconnect the cable from the control circuit and replace the control circuit.

14. A massaging apparatus system with a convenient replaceable control circuit as in claim 1, the control circuit further comprising at least a fast connector detachably connecting the fast connector on the cable.

15. A massaging apparatus system with a convenient replaceable control circuit as in claim 1, wherein the fast connector is configured in the cable proximal to the control circuit.

16. A massaging apparatus system with a convenient replaceable control circuit as in claim 1, wherein the body and the substantially closed storage space are a detachable panel of the body.

17. A massaging apparatus system with a convenient replaceable control circuit, comprising,
a body;
at least one massage head;
a control circuit;
a substantially closed storage space having at least one exit having a width of at least 10 mm,
a fastener to secure the substantially closed storage space opening,
a substantially closed storage space having a second exit for cable going through,
wherein the control circuit is stored in the substantially closed storage space,
wherein the control circuit has at least one cable with at least one fast connector that connects and disconnects the control circuit and massage head and goes through the second exit.

18. A massaging apparatus system with a convenient replaceable control circuit as in claim 17, wherein the body has a power source storage space and a power source, and the power source is connected with a cable extended from the substantially closed storage space.

19. A massaging apparatus system with a convenient replaceable control circuit as in claim 17, wherein the substantially closed storage space exit is made of elastic material.

20. A massaging apparatus system with a convenient replaceable control circuit as in claim 17, further comprising a function control board in communication with the control circuit.

21. A massaging apparatus system with a convenient replaceable control circuit as in claim 20, the function control board located in the shoulder strap of body, and connected by a cable extended from the substantially closed storage space.

22. A massaging apparatus system with a convenient replaceable control circuit as in claim 21, further comprising a rigid material under the function control board.

23. A massaging apparatus system with a convenient replaceable control circuit as in claim 17, wherein the cables forks to at least two cables to connect with the control circuit, the massage heads in the body, a power source, and connecting the function control board.

24. A massaging apparatus system with a convenient replaceable control circuit as in claim 17, the control circuit further comprising a second cable, wherein the second cable has at least one fast connector, to connect and disconnect the function control board and the control circuit.

25. A massaging apparatus system with a convenient replaceable control circuit as in claim 17, further comprising a third cable, wherein the third cable has at least one fast connector that connects and disconnects to a power source and the control circuit.

26. A massaging apparatus system with a convenient replaceable control circuit as in claim 17, the body further comprising a second substantially closed storage space with an cable exit to replace the massage head and for cable go through.

27. A massaging apparatus system with a convenient replaceable control circuit as in claim 16, wherein the cable connecting to the control circuit can be pulled out from the exit to disconnect the cable from the control circuit and replace the new control circuit.

28. A massaging apparatus system with a convenient replaceable control circuit as in claim 16, the control circuit further comprising at least a fast connector detachably connecting the fast connector on the cable.

29. A massaging apparatus system with a convenient replaceable control circuit as in claim 16, wherein the fast connector is configured in the cable proximal to the control circuit.

30. A massaging apparatus system with a convenient replaceable control circuit as in claim 16, wherein the body and the substantially closed storage space are a detachable panel of the body.
